(19) United States
(12) Patent Application Publication
(10) Pub. No.: US 2021/0368010 A1
(43) Pub. Date: Nov. 25, 2021

(54) COMPUTER IMPLEMENTED METHOD AND A COMPUTER SYSTEM FOR NAMING A VENUE

(71) Applicant: Praveen BARATAM, Visakhapatnam (IN)

(72) Inventor: Praveen BARATAM, Visakhapatnam (IN)

(21) Appl. No.: 16/966,571

(22) PCT Filed: Jan. 30, 2019
(86) PCT No.: PCT/IB2019/050730

§ 371 Date: Jul. 31, 2020

(30) Foreign Application Priority Data
Feb. 5, 2018 (IN) 201841004189

(51) Int. Cl. H04L 29/08; G06F 16/955

(52) U.S. Cl. CPC H04L 67/18; G06Q 30/0201; G06F 16/9566

(57) ABSTRACT

A computer implemented method (200) for naming a venue, the computer implemented method (200) comprising steps of receiving (210) geographical coordinates of a venue, from a client device (102), receiving (220) a unique identifier to be assigned to the venue, from the client device (102) and storing (230) the unique identifier in association with the geographical coordinates in storage device (112).

### TECHNICAL FIELD

The present disclosure, generally, relates to provision of a geographical location and more particularly to a computer implemented method and a computer system for naming a venue.

### BACKGROUND ART

Traditionally, addresses were used to locate any given place/venue/point of interest. Then with the advent of maps, GPS and geocoding, geographic coordinates or more specifically geodetic latitude and longitude values or similar notations from analogous systems such as, Universal Transverse Mercator [UTM], World Geographic Reference System (GEOREF), Maidenhead, Trimble Grid, Trimble Atlas, Thomas Brothers Detail, etc. are used to precisely locate a point of interest. However, all of the above methods suffer from terse and unfriendly expression formats that are inherently difficult to remember, recall and share. For instance, 149 W Laurel St #B, Philadelphia Pa. 19123 or 39.965233N, −75.139506 W are both difficult to remember, recall and share. Sometimes, a particular location does not even have an address and can only be identified using geo-coordinates making it even more difficult. For example, an interesting cave/arch in the Utah National Park.

In light of the discussion above, there is need for a computer implemented method and a computer system for naming a venue, which alleviates one or more of the above mentioned deficiencies.

### OBJECT OF THE INVENTION

An aspect of the present invention provides a computer implemented method for naming a venue.

Another aspect of the present invention provides a computer system for naming a venue.

### SUMMARY OF THE INVENTION

According to a first aspect of the present invention, there is provided a computer implemented method for naming a venue, comprising steps of receiving geographical coordinates of a venue, from a client device, receiving a unique identifier to be assigned to the venue, from the client device and storing the unique identifier in association with the geographical coordinates in a storage device.

In accordance with an embodiment of the present invention, the unique identifier includes at least a first element corresponding to a first level of a grouping and one or more subsequent elements of which every element except the last, if present, correspond to subsequent levels of grouping while the last element corresponds to the particular venue.

In accordance with an embodiment of the present invention, the geographical coordinates of the venue are determined by a GPS device available with the client device.

In accordance with an embodiment of the present invention, the geographical coordinates of the venue are received via an input device available with the client device.

In accordance with an embodiment of the present invention, the computer implemented method further comprises a step of receiving associated data corresponding to the venue and storing the associated data in association with the unique identifier and the geographical coordinates, in the storage device.

In accordance with an embodiment of the present invention, the computer implemented method further comprises a step of sharing the unique identifier and/or the associated data with a second client device.

In accordance with an embodiment of the present invention, the unique identifier and/or the associated data is shared via a Uniform Resource Locator (URL).

In accordance with an embodiment of the present invention, the computer implemented method further comprises steps of receiving second geographical coordinates and second associated data corresponding to the venue, from the client device and assigning the second geographical coordinates and the second associated data to the unique identifier by performing one or more of, replacing the geographical coordinates and the associated data, at least partially, with the second geographical coordinates and the second associated data and appending the second geographical coordinates and the second associated data to the geographical coordinates and the associated data.

In accordance with an embodiment of the present invention, the computer implemented method further comprises a step of assigning the unique identifier as an alias to a second venue.

In accordance with an embodiment of the present invention, the computer implemented method further comprises steps of receiving the URL/unique identifier from the client device and transmitting the geographical coordinates and the associated data to the client device in response to receiving the URL/unique identifier.

According to a second aspect of the present invention, there is provided a computer system for naming a venue. The computer system is in communication with a client device associated with a user, over a network. The computer system comprises a memory unit configured to store machine readable instructions, and a processor operably connected with the memory unit, the processor obtaining the machine-readable instructions from the memory unit, and being configured by the machine-readable instructions to receive geographical coordinates of a venue, from a client device, receive a unique identifier to be assigned to the venue, from the client device and store the unique identifier in association with the geographical coordinates in a storage device.

In accordance with an embodiment of the present invention, the unique identifier includes at least a first element corresponding to a first level of a grouping and one or more subsequent elements of which every element except the last, if present, correspond to subsequent levels of grouping while the last element corresponds to the particular venue.

In accordance with an embodiment of the present invention, the geographical coordinates of the venue are determined by a GPS device available with the client device.

In accordance with an embodiment of the present invention, the geographical coordinates of the venue are received via an input device available with the client device.

In accordance with an embodiment of the present invention, the processor is further configured to receive associated data corresponding to the venue and store the associated data in association with the unique identifier and the geographical coordinates, in the storage device.

In accordance with an embodiment of the present invention, the processor is further configured to share the unique identifier and/or the associated data with a second client device.

In accordance with an embodiment of the present invention, the unique identifier and/or the associated data is shared via a Uniform Resource Locator (URL).

In accordance with an embodiment of the present invention, the processor is further configured to receive second geographical coordinates and second associated data corresponding to the venue, from the client device and assign the second geographical coordinates and the second associated data to the unique identifier by performing one or more of, replace the geographical coordinates and the associated data, at least partially, with the second geographical coordinates and the second associated data and append the second geographical coordinates and the second associated data to the geographical coordinates and the associated data.

In accordance with an embodiment of the present invention, the processor is further configured to assign the unique identifier as an alias to a second venue.

In accordance with an embodiment of the present invention, the processor is further configured to receive the URL/unique identifier from the client device and transmit the geographical coordinates and the associated data to the client device in response to receiving the URL/unique identifier.

### BRIEF DESCRIPTION OF THE ACCOMPANYING DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 illustrates an exemplary environment of computing devices in which or with which various embodiments described herein may be implemented;

FIG. 2 illustrates a computer implemented method for naming a venue, in accordance with an embodiment of the present invention;

FIG. 3 illustrates an exemplary flow diagram for naming the venue, in accordance with an embodiment of the present invention; and

FIG. 4 illustrates an exemplary flow diagram of retrieving geographical coordinates and/or additional data corresponding to the venue, in accordance with an embodiment of the present invention.

### DETAILED DESCRIPTION OF THE PREFERRED EMBODIMENTS

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary, and are not intended to limit the scope of the invention.

Embodiments of the present invention aim to provide a computer implemented method and a computer system for naming a venue. Using the present invention, for naming the venue, a location (geo-coordinates) is identified using a GPS equipped smartphone or a personal computing device. Also, the location may be received by directly providing the location from the smartphone and attaching a unique name with one or more suffixes to the venue. The user can also provide relevant information such as title, address, description, contact number and e-mail address etc. The user can even add images and videos related to the location in order to provide an ease to end-users. Information submitted by the user would typically be sent via wireless communication to a server hosting software with a database for storage and retrieval. After the unique name with the one or more suffixes has been created, the user can share the same with other users.

Subsequently, anyone with the unique name and the one or more suffixes combination can retrieve the associated location and the attached information from the network service and/or directory. The location and the attached information may be retrieved using a Uniform Resource Locator (URL). The server then queries the database and retrieves the requested information. The user can view the relevant information, explore the location on a map, interact with the location's representatives etc.

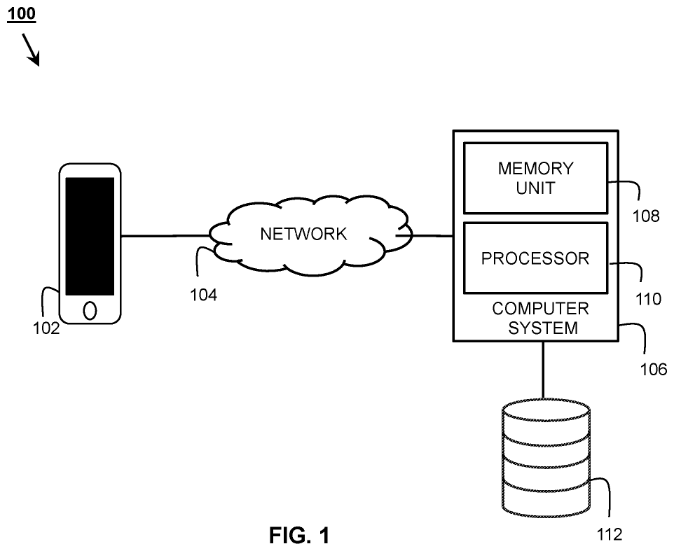

FIG. 1 illustrates an exemplary environment (100) of computing devices to which the various embodiments described herein may be implemented. As shown in FIG. 1, the environment (100) comprises a client device (102) associated with a user. In various embodiments, the client device (102) is selected from a group consisting of, but not limited to, mobile handheld devices such as cellular phones, PDAs and tablet PCs etc. or other computing devices such as desktop PCs and Notebooks etc. The client device (102) is connected with a network (104). The network (104) may be implemented through one or more plurality of protocols, such as, but not limited to, Ethernet, Wi-Fi, Bluetooth, ZigBee, GSM and CDMA etc. Further, the network (104) may be a Local Area Network (LAN) or a Wide Area Network (WAN). Preferably, the network (104) is Internet.

Further connected to the network (104) is a computer system (106). It is envisaged here that the computer system (106) has got computing capabilities, including, but not limited to, a memory unit (108) and a processor (110) operably connected with the memory unit (108). The memory unit (108) may be a non-volatile memory unit, such as, but not limited to, EPROM, EEPROM and Flash Memory. In various embodiments, the memory unit (108) may be a volatile memory unit, such as, but not limited to, primary storage (typically dynamic RAM, DRAM), and fast CPU cache memory (typically static RAM, SRAM). The processor (110) may be, for example, a general purpose processor, an Application Specific Integrated Circuit (ASIC) or a Field Programmable Gate Array (FPGA), etc. The memory unit (108) is configured to store machine readable instructions. The machine readable instructions may be loaded into the memory unit (108) from a non-transitory computer readable medium. A storage device (112) capable of storing unique identifier and additional data is connected with the computer system (106). In accordance with an embodiment, the storage device (112) processes queries in a plurality of languages and protocols comprising, but not limited to, Structured Query Language (SQL), QL and Datalog etc. The storage device (112) may be a local storage device or a cloud based storage device. Various embodiments may now be understood by taking the exemplary environment (100) as a reference.

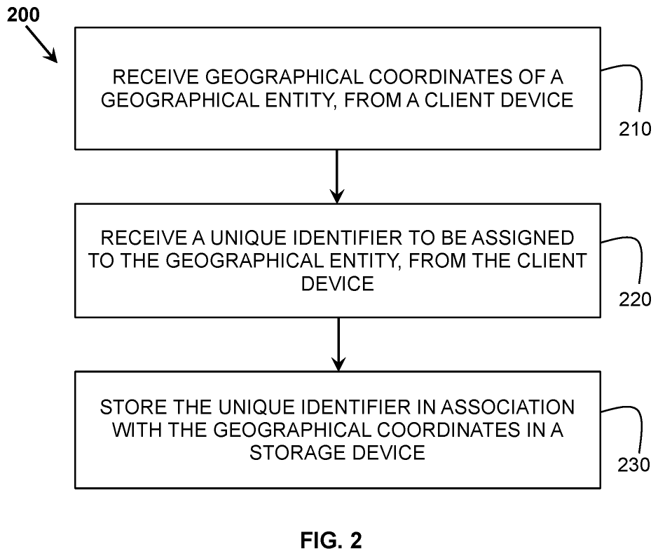

FIG. 2 illustrates a computer implemented method (200) for naming a venue, in accordance with an embodiment of the present invention. The method begins at step 210, by receiving geographical coordinates of the venue. The geographical coordinates are received from the client device (102), at the computer system (106). A geographical coordinate system typically represents an imaginary three-dimensional spherical surface that enables every location on Earth to be specified by a set of numbers, letters and/or symbols. The geographical coordinates are often chosen such that one of the numbers may represent a vertical position and two or three of the numbers may represent a horizontal position. Preferably, a common choice of geographical coordinates is latitude, longitude and elevation.

In a typical scenario involving a modern computing device, the geographical coordinates of the venue may be determined by a Global Positioning System (GPS) device available with the client device (102). In various other embodiments, due to unavailability of the GPS device with the client device (102) or due to unavailability of the GPS network, or due to inability of the GPS device to retrieve the geographical coordinates, the user may have to manually enter the geographical coordinates. In such a scenario, the geographical coordinates of the venue are received via an input device available with the client device (102), at the computer system (106). It is contemplated here that either an address or an area or a nearest Point of Interest (POI) is received from the client device (102) in order to retrieve the geographical coordinates. Also, in case, the client device (102) is not present at the venue to be named, the GPS device with the client device (102) may not be useful for retrieving the geographic coordinates of the venue. Herein, the user may have to manually search an address or an area or a nearest landmark followed by pinpointing the venue on the map in order to retrieve the geographical coordinates.

At step 220, a unique identifier is received from the client device (102), after receiving the geographical coordinates of the venue. The unique identifier may be received using non-standard naming convention. In general, for a naming convention, each name is unique for same scope. It is envisaged here that naming convention may be a set of rules for choosing character sequence to be used for identifiers that denote variables, types, functions and other entities. In various embodiments, the unique identifier includes, but not limited to, a first element corresponding to a first level of a grouping and one or more subsequent elements of which every element except the last, if present, correspond to subsequent levels of grouping while the last element corresponds to the particular venue. Herein, the unique identifier is unique name (first element)+one or more suffixes (subsequent elements). The unique identifier may also include any number of such additional elements in form of the one or more suffixes and one or more prefixes as may be necessary to group the unique identifier as per a plurality of levels of groupings. Further, the unique identifier is assigned to the venue, at the computer system (106).

For example, McDonalds.NYC.TS for McDonalds's Restaurant in Times Square, Manhattan. As depicted above, the unique name i.e. McDonalds may additionally point to a plurality of locations by adding the relevant one or more suffixes such as NYC and TS to McDonalds. The above naming convention affords the plurality of locations to be organized and grouped into a plurality of sets, a plurality of subsets and so on based on geography and/or purpose. Depending on writing/reading convention, the user may remove the last token from the unique name+the one or more suffixes combination comprising the unique identifier to refer to and to retrieve a super group/encapsulating group.

In McDonalds.NYC.TS described above, McDonalds.NYC may refer to a group of locations wherein McDonald's restaurants in New York City may be retrieved. Also, McDonalds may refer to the super group of all the McDonalds restaurants catalogued on respective service. For another instance, Mr. Amit Sharma may name his house AMITSHARMA.KOLKATA.HOME. Hence, when Mr. Amit may want to refer someone to his Kolkata house, he may identify his venue using AMITSHARMA.KOLKATA.HOME.

After receiving the unique identifier, associated data corresponding to the venue may be received from the client device (102). In various embodiments, the associated data may include metadata and media artifacts. Further, metadata may be one or more of, title, description, address, contact number and e-mail address corresponding to the venue. Also, media artifacts include, but not limited to, one or more images and one or more videos corresponding to the venue. In case, the associated data is the media artifacts, the media artifacts may be uploaded from the client device (102), through the computer system (106).

At step 230, after the unique identifier and the associated data is received, the unique identifier is stored in association with the geographical coordinates, in the storage device (112). Additionally, the associated data is stored in association with the unique identifier and the geographical coordinates, in the storage device (112). It is contemplated here that the storage device (112) includes a plurality of data cells configured to store the unique identifier and the associated data in a dedicated data cell. In accordance with an embodiment, the unique identifier and/or the associated data may be shared with a second client device, through the computer system (106). Further, the second client device (not shown) corresponds to a second user.

The unique identifier and/or the associated data are shared via a Uniform Resource Locator (URL). Also, the URL may point to the unique identifier and/or the associated data. In case, the URL is not available then the unique identifier (unique name (first element)+one or more suffixes (subsequent elements)) may be received from the client device (102). In addition, the computer system (106) may query the network (104) and/or the storage device (112) and retrieves the geographical coordinates and the associated data. Further, the geographical coordinates and the associated data are transmitted to the client device (102) in response to receiving the unique identifier.

Also, the additional data corresponding to the venue may be viewed on a display screen of the client device (102). Moreover, the venue may be explored and navigated to. In addition, a desired user may be contacted either online and/or offline. Over and above that, one or more users interested in the venue may interact with each other and/or with one or more representatives of the venue. In accordance with an embodiment, the unique identifier may be assigned as an alias to a second venue.

Additionally, the geographical coordinates and/or the additional data may be updated (to reflect a change in premises or the like) corresponding to the venue. Herein, second geographical coordinates and second associated data is received from the client device (102). Further, the second geographical coordinates and the second associated data are assigned to the unique identifier by performing one or more of, either the second geographical coordinates and/or the second additional data may be appended with the geographical coordinates and/or the additional data or replaced with the geographical coordinates and/or the additional data or both, based on the change in premises or the like. In one example, the second geographical coordinates and/or the second additional data may be replaced fully with the geographical coordinates and/or the additional data. In another example, the second geographical coordinates and/or the second additional data may be appended fully with the geographical coordinates and/or the additional data. In yet another example, a part of the geographical coordinates and/or the additional data may be replaced with a part of the second geographical coordinates and/or the second additional data. Hence, the plurality of data cells in the storage device (112) gets altered based on the inputs received from the client device (102).

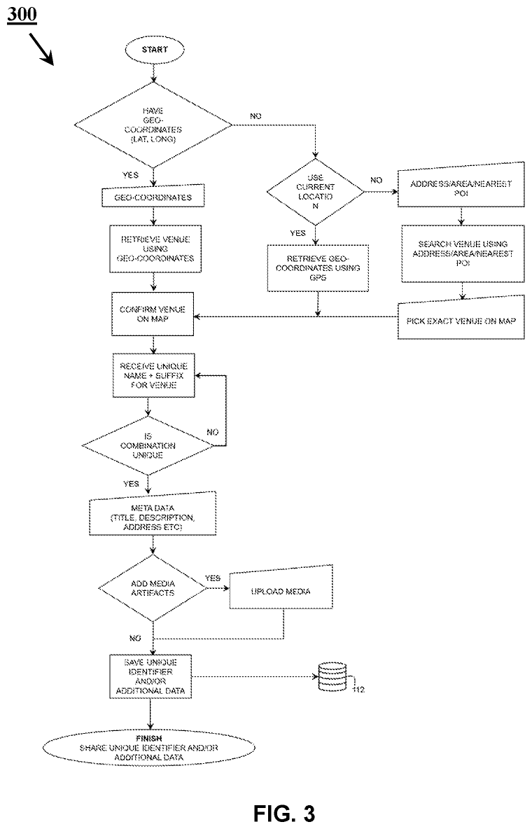

FIG. 3 illustrates an exemplary flow diagram (300) for naming the venue, in accordance with an embodiment of the present invention. The flow begins at step 301 by, receiving the geographical coordinates from the client device (102) (shown in FIG. 1) associated with the user. Further, the venue may be retrieved using the geographical coordinates at step 302. Referring to step 303, there may be case, when the geographical coordinates may not be available with the client device (102). In such a case, if the client device (102) is at the venue, the geographical coordinates of the current location may be retrieved using GPS available with the client device (102). In another case, when the geographic coordinates of the venue may not be known or the client device (102) may not be present at the venue, in such a case, referring to step 304, either the address or the area or the nearest POI may be received from the client device (102). Additionally, at step 305, the user may manually search the venue in the search query using the address or the area or the nearest POI that is followed by pinpointing the venue on the map at step 306. Further, at step 307, after retrieving the respective venue, the venue on the map is confirmed through the client device (102).

At step 308, the unique identifier for the respective venue is received from the client device (102). The unique identifier is a combination of the unique name with the one or more suffixes. The unique identifier should be unique. The naming convention may include multiple levels of grouping that may be grouped into the plurality of sets, the plurality of subsets and so on based on geography, function, purpose, etc. At step 309, a server may check the unique identifier received from the client device (102) against those stored in the storage device (112) (shown in FIG. 1) as only a unique combination will be accepted by the server. In case, the combination is not unique, a pop up or an alert may be received at the client device (102) in order to provide unique combination. For example, Mr. Ram may name his house RAM.NEWDELHI which may refer to the group of locations wherein multiple estates present in New Delhi belonging to person Ram, may be retrieved and the combination may not be considered a unique one. Further, an additional suffix may be provided i.e. RAM.NEWDELHI.PREETVIHAR.

The unique identifier “RAM.NEWDELHI.PREETVIHAR” may be a unique combination and may refer to a house present in New Delhi in Preet Vihar and belonging to a person named Ram. There might be scenario when the above combination may also not be considered the unique. In that scenario, another level of grouping may be defined. Herein, an additional prefix or suffix may be added to the above defined unique identifier, for example, 502.RAM.NEWDELHI.PREETVIHAR in order to refer to and retrieve the particular venue.

After the unique identifier is received from the client device (102), the additional data may be added corresponding to the venue. The additional data may be metadata and media artifacts. At step 310, metadata may be received from the client device (102). Metadata may be, but not limited to, title, description, address related to the venue. Further at step 311, in case the user needs to add media artifacts related to the venue, in this case, the user may upload the media from the client device (102) at step 312. At step 313, the unique identifier and/or the additional data may be saved in the storage device (112). In case, the media artifacts may not be added, in that case, the unique identifier and the metadata may be saved in the storage device (112). In another case, if the media artifacts may be uploaded then the unique identifier along with the metadata and the media artifacts may be saved in the storage device (112). In addition, at step 314, the unique identifier may be shared with the one or more users.

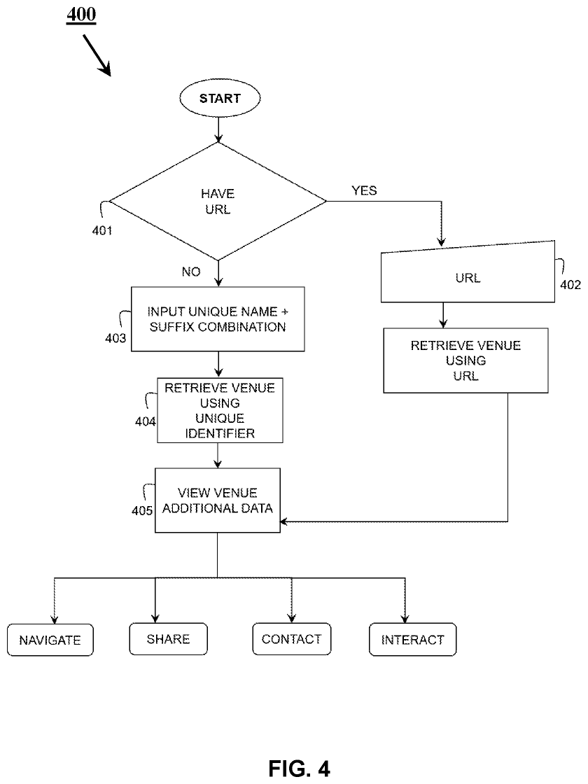

Referring to an embodiment (400) of FIG. 4, the unique identifier and/or the associated data may be shared via the URL. Further, the URL may or may not be available in order to retrieve the geographical coordinates and/or the additional data related to the venue. At step 401, in case, the URL may be available, the respective geographical coordinates and/or the additional data related to the venue may be retrieved using the URL at step 402. The URL may refer to the unique identifier and/or the associated data. Further, in another case, the URL may not be available, at step 403, the unique name with the one or more suffixes combination may be received from the second client device. Further, at step 404, the respective venue may be retrieved using the unique identifier. After the respective venue may be retrieved, at step 405, the additional data (if any) corresponding to the venue may be seen on the display screen of the second client device. Furthermore, the respective venue may be explored on the map and/or the one or more users may interact with each other.

The present invention offers a number of advantages. The present invention enables the client device (102) associated with the user to provide unique name with the one or more suffixes that give context and/or additional meaning to the venue of interest. Further, the present invention allows personalizing the venue with metadata such as, but not limited to, title, description, contact number or the like and media artifacts such as, but not limited to, images, videos, layout plans, etc. for sharing with whosoever is interested.

In some examples, the systems described herein, may include one or more processors, one or more forms of memory, one or more input devices/interfaces, one or more output devices/interfaces, and machine-readable instructions that when executed by the one or more processors cause the system to carry out the various operations, tasks, capabilities, etc., described above.

In some embodiments, the disclosed techniques can be implemented, at least in part, by computer program instructions encoded on a non-transitory computer-readable storage media in a machine-readable format, or on other non-transitory media or articles of manufacture. Such computing systems (and non-transitory computer-readable program instructions) can be configured according to at least some embodiments presented herein, including the processes described in above description.

The programming instructions can be, for example, computer executable and/or logic implemented instructions. In some examples, a computing device is configured to provide various operations, functions, or actions in response to the programming instructions conveyed to the computing device by one or more of the computer readable medium, the computer recordable medium, and/or the communications medium. The non-transitory computer readable medium can also be distributed among multiple data storage elements, which could be remotely located from each other. The computing device that executes some or all of the stored instructions can be a microfabrication controller, or another computing platform. Alternatively, the computing device that executes some or all of the stored instructions could be remotely located computer system, such as a server.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

Further, while one or more operations have been described as being performed by or otherwise related to certain modules, devices or entities, the operations may be performed by or otherwise related to any module, device or entity. As such, any function or operation that has been described as being performed by a module could alternatively be performed by a different server, by the cloud computing platform, or a combination thereof.

Further, the operations need not be performed in the disclosed order, although in some examples, an order may be preferred. Also, not all functions need to be performed to achieve the desired advantages of the disclosed system and method, and therefore not all functions are required.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claims.

I claim:

1. A computer implemented method (200) for naming a venue, the computer implemented method (200) comprising steps of:
receiving (210) geographical coordinates of a venue, from a client device (102);
receiving (220) a unique identifier to be assigned to the venue, from the client device (102); and
storing (230) the unique identifier in association with the geographical coordinates in a storage device (112).

2. The computer implemented method (200) as claimed in claim 1, wherein the unique identifier includes at least a first element corresponding to a first level of a grouping and one or more subsequent elements of which every element except the last, if present, correspond to subsequent levels of grouping while the last element corresponds to the particular venue.

3. The computer implemented method (200) as claimed in claim 1, wherein the geographical coordinates of the venue are determined by a GPS device available with the client device (102).

4. The computer implemented method (200) as claimed in claim 1, wherein the geographical coordinates of the venue are received via an input device available with the client device (102).

5. The computer implemented method (200) as claimed in claim 1, further comprising a step of receiving associated data corresponding to the venue and storing the associated data in association with the unique identifier and the geographical coordinates, in the storage device (112).

6. The computer implemented method (200) as claimed in claim 5, further comprising a step of sharing the unique identifier and/or the associated data with a second client device.

7. The computer implemented method (200) as claimed in claim 6, wherein the unique identifier and/or the associated data is shared via a Uniform Resource Locator (URL) pointing to the associated data and/or the unique identifier.

8. The computer implemented method (200) as claimed in claim 5, further comprising steps of:
receiving second geographical coordinates and second associated data corresponding to the venue, from the client device (102); and
assigning the second geographical coordinates and the second associated data to the unique identifier by performing one or more of:
replacing the geographical coordinates and the associated data, at least partially, with the second geographical coordinates and the second associated data; and
appending the second geographical coordinates and the second associated data to the geographical coordinates and the associated data.

9. The computer implemented method (200) as claimed in claim 1, further comprising a step of assigning the unique identifier as an alias to a second venue.

10. The computer implemented method (200) as claimed in claim 1, further comprising steps of:
receiving a URL or receiving the unique identifier from the client device (102); and
transmitting the geographical coordinates and the associated data to the client device (102) in response to receiving the unique identifier/URL.

11. A computer system (106) for naming a venue, the computer system (106) being in communication with the client device (102) associated with a user, over a communication network (104), the computer system (106) comprising:
a memory unit (108) configured to store machine readable instructions;
a processor (110) operably connected with the memory unit (108), the processor (110) obtaining the machine-readable instructions from the memory unit (108), and being configured by the machine-readable instructions to:
receive geographical coordinates of a venue, from a client device (102);
receive a unique identifier to be assigned to the venue, from the client device (102); and
store the unique identifier in association with the geographical coordinates in a storage device (112).

12. The computer system (106) as claimed in claim 11, wherein the unique identifier includes at least a first element corresponding to a first level of a grouping and one or more subsequent elements of which every element except the last, if present, correspond to subsequent levels of grouping while the last element corresponds to a particular venue.

13. The computer system (106) as claimed in claim 11, wherein the geographical coordinates of the venue are determined by a GPS device available with the client device (102).

14. The computer system (106) as claimed in claim 11, wherein the geographical coordinates of the venue are received via an input device available with the client device (102).

15. The computer system (106) as claimed in claim 11, wherein the processor (110) is further configured to receive associated data corresponding to the venue and store the associated data in association with the unique identifier and the geographical coordinates, in the storage device (112).

16. The computer system (106) as claimed in claim 15, wherein the processor (110) is further configured to share the unique identifier and/or the associated data with a second client device.

17. The computer system (106) as claimed in claim 16, wherein the unique identifier and/or the associated data is shared via a Uniform Resource Locator (URL) pointing to the associated data and/or the unique identifier.

18. The computer system (106) as claimed in claim 15, wherein the processor (110) is further configured to:
receive second geographical coordinates and second associated data corresponding to the venue, from the client device (102); and
assign the second geographical coordinates and the second associated data to the unique identifier by performing one or more of:
replace the geographical coordinates and the associated data, at least partially, with the second geographical coordinates and the second associated data; and
append the second geographical coordinates and the second associated data to the geographical coordinates and the associated data.

19. The computer system (106) as claimed in claim 11, wherein the processor (110) is further configured to assign the unique identifier as an alias to a second venue.

20. The computer system (106) as claimed in claim 11, wherein the processor (110) is further configured to:
receive a URL or receive the unique identifier from the client device (102); and
transmit the geographical coordinates and the associated data to the client device (102) in response to receiving the unique identifier/URL.
